(19) United States
(12) Patent Application Publication
(10) Pub. No.: US 2011/0309550 A1
(43) Pub. Date: Dec. 22, 2011

(54) PRE-FORMING METHOD FOR MAKING FILM AND HEATING DEVICE USED FOR THE METHOD

(75) Inventors: ZHI-FENG ZHAO, Shenzhen City (CN); HUAN-BING YE, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/889,602

(22) Filed: Sep. 24, 2010

(30) Foreign Application Priority Data
Jun. 21, 2010 (CN) 201010204859.6

(51) Int. Cl. B29C 51/08; B28B 11/10

(52) U.S. Cl. 264/322; 425/397

(57) ABSTRACT

A pre-forming method for a film includes: providing a pressing mold including a lower mold and an upper mold, the lower mold defining a cavity; placing a film into the cavity, the film having patterns printed thereon; providing a heating device including a heating unit and a fixing unit, the heating unit heating and the fixing unit pressing the area of the film having the pattern, the film being softened; removing the heating device form the pressing mold and the pressing mold being closed, the film being heated further to soft; cooling and opening the pressing mold, removing the three-dimensionally shaped film from the mold without distorting the pattern.

### BACKGROUND

1. Technical Field

The present disclosure relates to pre-forming methods for making films and heating devices for used with the method.

2. Description of Related Art

Insert molding label (IML) is used to fabricate a molded article with an outer decorative film. Before molding the molded article, the decorative film needs to be fit into a three-dimensional chamber of the mold. During the fabrication of the decorative film, the film of a planar shape is printed to form patterns, then the printed film is heated and pressed to form three-dimensional shapes.

However, due to the expansion rate of the film, the patterns on the film tend to deform when being heated and pressed.

Therefore, there is room for improvement within the art.

### BRIEF DESCRIPTION OF THE DRAWINGS

Many aspects of the present pre-forming method for making film and heating device used for the method can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the diagrams.

FIG. 1 is an exploded schematic view of an apparatus used to fabricate a decorative film according to an exemplary embodiment.

FIG. 2 is a schematic view during the film in fabrication process.

### DETAILED DESCRIPTION

In the exemplary embodiment, the original film is planar and rectangular, with a surface of the film having printed patterns thereon. The film can be pre-formed to have a three-dimensional shape to fit into a chamber in a mold, and then be used in IML to form the outer surface of a housing for an electronic device, such as a mobile phone, or a personal digital assistant. The film may be made of a resin material selected from a group including polycarbonate, polymethyl methacrylate, polystyrene, or any desired combination thereof.

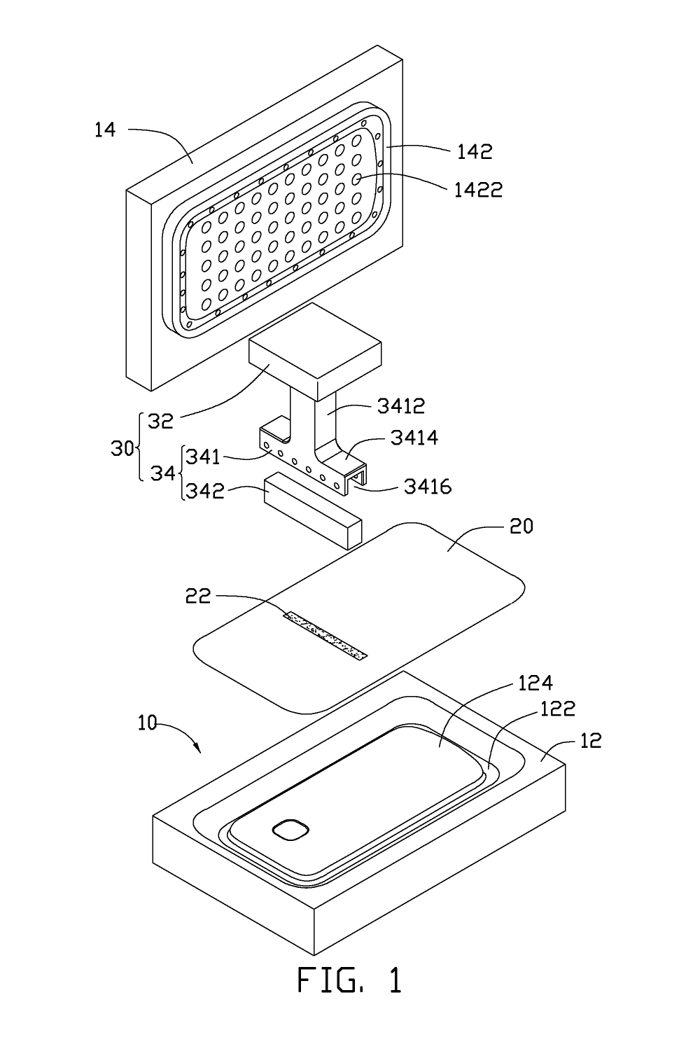

FIG. 1 shows a processing apparatus for pre-forming the film. The processing apparatus includes a pressing mold 10 and a heating device 30. The pressing mold 10 includes a lower mold 12 and an upper mold 14 engageable with the lower mold 12. The lower mold 12 defines at least one cavity 122 in the lower mold surface facing the upper mold 14, in this embodiment, four cavities are defined in the lower mold surface. A protrusion 124 protruding from the bottom of the cavity 122 has a three-dimensional outer contour. The protrusion 124 can secure a film 20 thereon and engage with the upper mold 14 to pre-form the film 20.

The upper mold 14 forms at least a core 142 corresponding to the cavity 122 in the upper mold surface facing the lower mold 12. The core 142 defines heat-dissipation holes 1422 for heating the film 20. When the upper mold 14 engages the lower mold 12, the core 142 extends into the cavity 122 and approaches the film 20. Heat from the heat-dissipation holes 1422 softens the film 20.

The heating device 30 includes a heating unit 32 and a fixing unit 34 assembled under the heating unit 32. The heating unit 32 is used to heat and soften the film 20. The heating unit 32 can be chosen from a ceramic body having resistance wires positioned inside with the resistance wires being heated by electricity and the heat being transmitted to the ceramic body, the ceramic body dissipates the heat evenly. The fixing unit 34 includes a connecting member 341 and a pressing body 342 secured to the connecting member 341. The connecting member 341 includes a supporting portion 3412 and a clamping portion 3414 connecting to the supporting portion 3412. The supporting portion 3412 connects and supports the heating unit 32. The clamping portion 3414 defines a clamping groove 3416 for clamping the pressing body 342. The pressing body 342 is used to press a portion of the film 20 having the patterns thereon to prevent the patterns from distorting. The pressing body 342 may be a silica gel having good resistance to high temperature. For example, a silica gel having a hardness of about 75 to 80 HR can be used. Due to the pressing body 342 being made from a silica gel, when the pressing body 342 presses the film 20, the film 20 can not be damaged.

The film 20 can be a number of materials such as resin film or leather. In the exemplary embodiment, the film 20 can be a transparent, rectangular film having a pattern 22 printed on the surface thereof. The pattern 22 has a high precision requirement and cannot be distorted when the film 20 is processed. The pattern 22 can be a logo.

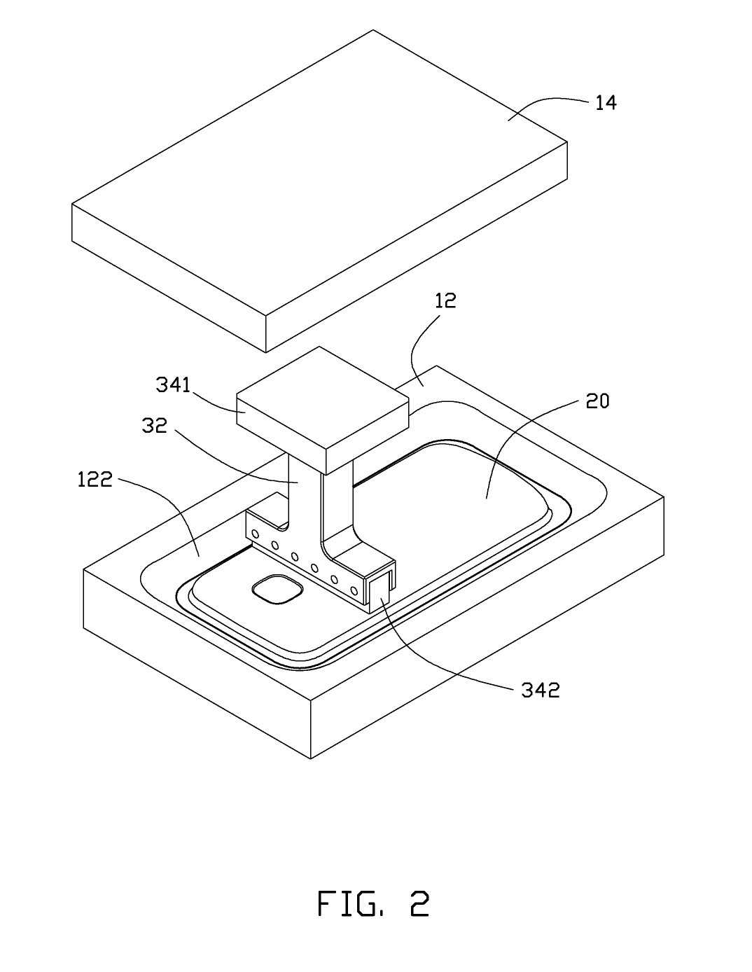

Referring to FIG. 2, to pre-form the film 20, the film 20 is secured on the protrusion 124 of the lower mold 12, with the surface having the pattern 22 of the film 20 abutting on the protrusion 124. The heating device 30 is moved into the space between the upper mold 14 and the lower mold 12, and the area of the film 20 having the pattern 22 printed is pressed by the pressing body 342. The heating unit 32 dissipates heat to soften the film 20. After a time, the film 20 is substantially soft and entirely abuts on the protrusion 124. The film 20 is shaped consistent with the corresponding three-dimensional outer contour of the protrusion 124. During the processing, the pressing body 342 presses the area having the pattern 22 of the film 20, the area of the pattern 22 cannot expand and the pattern 22 can not distort, so the pattern 22 can be protected.

Then, the heating device 30 is removed from the space between the upper mold 14 and the lower mold 12, and the pressing body 342 is lifted and separated from the film 20. After that, the upper mold 14 engages with the lower mold 12, the core 142 extends into the cavity 122 and approaches to the distorted film 20. The abutting of the core 142 against the film 20 is freed to prevent the core 142 from damaging the film 20. The heat-dissipation holes 1422 of the core 142 are aligned with the film 20, and heat passes through the heat-dissipation holes 1422 and dissipate to soften the film 20, further shaping of the film 20 softens it sufficiently and consistently with the three-dimensional outer contour of the protrusion 124. The temperature in the pressing mold 10 can be controlled to make sure all the areas of the film 20 has a pattern 22 without distortions. Accordingly, the pre-formation of the film 20 is finished.

Then, the pressing mold 10 is cooled and the distorted film 20 is pre-formed, and the pressing mold 10 is opened so the film 20 can be taken out. In this case, the film 20 has a stable three-dimensional shape.

It is to be understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A pre-forming method for making a film, comprising:
providing a pressing mold including a lower mold and an upper mold engageable with the lower mold, the lower mold defining a cavity and the upper mold forming a core to engage with the cavity;
providing a film for pre-forming, the film having patterns printed thereon;
placing the film in the cavity;
providing a heating device including a heating unit and a fixing unit assembled under the heating unit;
placing the heating device between the lower mold and the upper mold, the heating unit heating and the fixing unit pressing the area of the film having the pattern, the film being softened;
removing the heating device from between the lower mold and the upper mold;
engaging the upper mold with the lower mold, the core dissipating heat to further soften the film into a shape corresponding to the shape of the cavity;
cooling and opening the pressing mold, removing the three-dimensionally shaped film from the mold without distorting the pattern.

2. The pre-forming method for a film as claimed in claim 1, wherein the cavity has a protrusion protruding from the bottom, the protrusion having a three-dimensional outer contour for securing the film thereon.

3. The pre-forming method for a film as claimed in claim 2, wherein the film is secured on the protrusion of the lower mold, with the surface of the film having the pattern abutting the protrusion.

4. The pre-forming method for a film as claimed in claim 1, wherein the lower mold defines at least a cavity in the lower mold surface facing the upper mold, the upper mold forms at least a core corresponding to the cavity in the upper mold surface facing the lower mold.

5. The pre-forming method for a film as claimed in claim 1, wherein the core extends into the cavity and approaches the film without abutting the film.

6. The pre-forming method for a film as claimed in claim 1, wherein the core defines heat-dissipation holes, heat from the heat-dissipation holes softens the film.

7. The pre-forming method for a film as claimed in claim 1, wherein the film can be a resin film or leather.

8. A heating device for pre-forming a film, comprising:
a heating unit;
a fixing unit connecting to the heating unit, the fixing unit including a connecting member and a pressing body assembled in the connecting member, the connecting member connecting to the heating unit, the pressing body for pressing the film to be pre-formed.

9. The heating device as claimed in claim 8, wherein the pressing body comprises a silica gel having a hardness of about 75 to 80 HR.

10. The heating device as claimed in claim 8, wherein the connecting member include a supporting portion and a clamping portion, the supporting portion connects to and supports the heating unit, the clamping portion defines a clamping groove to clamp the pressing body.

11. The heating device as claimed in claim 8, wherein the heating unit can be chosen from a ceramic body having resistance wires positioned inside.
